(19) United States
(12) Patent Application Publication
(10) Pub. No.: US 2012/0084216 A1
(43) Pub. Date: Apr. 5, 2012

(54) WARRANTY AND TIME CRITICAL CONTRACT TRACKING SYSTEM

(76) Inventor: Christopher Williamson, Darlinghurst (AU)

(21) Appl. No.: 13/377,604

(22) PCT Filed: Jun. 10, 2010
(86) PCT No.: PCT/AU2010/000719

§ 371 Date: Dec. 12, 2011

(30) Foreign Application Priority Data
Jun. 12, 2009 (AU) 2009902692

(51) Int. Cl. G06Q 10/00

(52) U.S. Cl. 705/302

(57) ABSTRACT

A system (10) for tracking warranties and other time critical contracts. The system (10) includes a data store (12) for storing at least authentication information for authenticating a user to the system and contract information including start date and end date of the contract being tracked. The system (10) also includes a processor (13) adapted to access the data store and from the information made available in the data store, determining one or dates regarding time critical contracts, and for directing communications with a user via a communications module (14) which is adapted to send and receive information to and from a user's networked device including a mobile telephone (16) or a computer (18) and where the information sent to the device includes at least, an alert reminding the user that the contract is about to expire, in advance of the end date of a contract being tracked.

### TECHNICAL FIELD

The present invention relates generally to warranties, contracts and other time critical contracts, and more particularly, to an internet mediated warranty and time critical contract tracking system.

### BACKGROUND ART

Between 2% to 8% of the cost of most consumer items is allocated by manufacturers for warranty claims. For example, if $2.5 billion is spent per annum on mobile phones nationwide, then around 5% of that total, or $125 million, is allocated for warranty claims. However, many consumers lose track of their warranties, miss the warranty claim deadline and thereby fail to extract the value for warranties built into the price of consumer items.

Warranties may be difficult to track. For instance, some consumer items have different warranty periods for different components. A car's paintwork, bodywork and drive chains may have different warranties periods. Developers may also find it difficult to track the warranties on the numerous consumer items within their buildings.

Contracts and time based contracts are being entered into on an increasing frequency for utilities, pay TV, Internet, mobile communications passports and subscriptions. This increasing quantity of contracts is also difficult to track. For example, an electricity service supply contract may be signed for two years and the consumer may want to track that contract with the view to seeking a lower cost service with another supplier when the contract expires. Each year in Australia approximately one billion dollars is spent on retail gift vouchers and many have expiration dates. It was also reported that one in three gift retail vouchers in Australia are not redeemed within the required time period. Dockets for lay-by purchases are often lost and go unredeemed.

In some countries, motor vehicle driving licences expire without renewal notices being sent to drivers. In these countries, it is the driver's responsibility to remember and renew an expired licence. The impact of not renewing could mean that drivers may drive unlicensed and therefore uninsured. In this case, listing a driver's licence in an easy to user consumer system will reduce the chance of the consumer forgetting about their renewal.

In some instances, evergreen contracts are becoming more common. These evergreen contracts automatically renew on expiration unless the consumer or business to opt-out prior to that conclusion date. Often there are also strict windows of opportunity prior to that expiry date to opt-out. These evergreen contracts may go on in perpetuity due to one party not taking action during the nominated time period.

Traditional printed calendars do not have the capacity to record details years in advance. Long term electronic calendars can also fail due to migration of technology, transferring of calendar data, importing and exporting existing calendars to new platform and performing these functions over various technology life cycles (e.g. a mobile phone, tablet computers or laptop computers).

Although prior art computer calendar applications are adapted to remind users of particular dates, they are not adapted to provide warranty countdowns, send a series of timely reminders via SMS or email, store copies of the warranties, provide receipts when tax returns are due, provide the means for extending warranties, electronically transfer receipts and warranty documentation from a previous owner to a new owner, provide manufacturer's contact details, provide a forum for customer experiences, or provide information relevant to warranty claims.

There are some highly specialised document reminder systems that are used by law firms and similar businesses that need to track due dates. A problem with these prior art document reminder systems is that they are not adapted for use with warranty contracts. Further, these prior art document reminder systems are not adapted to capture contract formation at the time of formation, as the user may not be stationed in front of a desktop computer at that point in time. Moreover, these prior art document reminder systems are generally complex, difficult to use, and not directed at consumers for use in respect of consumer goods.

### DISCLOSURE OF INVENTION

According to a first aspect of the present invention, there is provided a system for tracking warranties and other time critical contracts, the system comprising:
(i) a data store for storing at least:
   a. authentication information for authenticating a user to the system and
   b. contract information including start date and end date of the contracts being tracked;
(ii) a processor adapted to access the data store and from the information made available in the data store, determining one or dates regarding time critical contracts, and for directing communications with a user via,
(iii) a communications module adapted for sending and receiving information to and from a user device comprising a mobile telephone or a computer, wherein the user device further comprises input means, communication means and display means;
wherein the system is adapted to send to the user information concerning time critical contacts including at least, an alert before the end date of the contract being tracked.

Preferably, the authentication information is comprised of a username and password.

More preferably, the username is the user's email address.

It is also preferred that the one or more dates regarding time critical contracts includes multiple dates on which reminders regarding pending contract expiry should be sent to a device of a user and wherein the processing means directs the communications module to send to a device of a user multiple reminders regarding pending contract expiry.

In a preferred embodiment the data store further includes one or more dates that relate to conditions of the contract and wherein the one or more dates regarding time critical contracts includes dates on which reminders regarding pending contract conditions should be sent to a device of a user and wherein the processing means directs the communications module to send to a device of a user reminders regarding pending contract conditions.

In a preferred form, the condition of the contract includes reminders to service any equipment which is the subject of a contract of warranty in advance of the deadline for servicing.

Preferably, the communications module communicates information to a user via either or all of email, SMS, MMS or via other social networking protocols and messaging platforms.

More preferably, the system is further adapted to receive from user devices, copies of receipts, warranty documents or contracts for storage in the data store for later retrieval by the user.

It is also preferred that additional information such as product specifications or terms and conditions can be stored in the data store, wherein the additional information is obtained from the vendor's web site or another repository of information.

In a preferred embodiment, the system obtains the additional information automatically from a vendor's online repository of information or website, via the communications module and the internet.

In a preferred form, the system includes the ability to customise the arrangement of information reported to the user.

Preferably, the processing means is adapted to receive and process a request made by a user to transfer some or all of a user's information concerning time critical contracts to a different user's account.

More preferably, the system provides a forum for user's information which can be displayed via the display means to other users.

It is also preferred that each account holder can grant partial or complete access to their account to other persons where the other person is identified through their own authentication information, including username and password.

In a preferred embodiment the data store also records information in respect of other time critical documents that have an expiry date, other than contracts and the system is adapted to send reminder messages in advance of the expiry of the time critical documents to a user's device.

According to a second aspect of the present invention, there is provided a computer or mobile phone when used to communicate with a system for tracking warranties and other time critical contracts, wherein the system comprises:
(a) a data store for storing at least:
   (i) authentication information for authenticating a user to the system;
   (ii) contract information including start date and end date of the contract being tracked;
(b) a processor adapted to access the data store and from the information made available in the data store, determining one or dates regarding time critical contracts, and for direction communications with a user via,
(c) a communications module adapted for sending and receiving information to and from a user device comprising a mobile telephone or computer;

wherein the computer or mobile telephone comprises input means, communication means, and display means for
(i) receiving a users input including input concerning contract information
(ii) sending the user's input to the communications module of the system for analysis and storage in the data store; and/or,
(iii) receiving information from the communication module of the system and displaying that information to the user.

Preferably, the computer or mobile telephone also includes a camera for taking photos any of receipts, contracts or warranties for uploading to the system and for storage in the system data store.

According to a third aspect of the present invention, there is provided a computer application for use on a computer or mobile telephone having input means, communication means and display means, wherein the computer application adapts the computer or mobile telephone to communicate with a system for tracking warranties and other time critical contracts, wherein the system comprises:
(a) a data store for storing at least:
   (i) authentication information for authenticating a user to the system;
   (ii) contract information including start date and end date of the contract being tracked;
(b) a processor adapted to access the data store and from the information made available in the data store, determining one or dates regarding time critical contracts, and for direction communications with a user via,
(c) a communications module adapted for sending and receiving information to and from a user device comprising a computer or mobile telephone, wherein the computer module further comprises input means and display means;

wherein the computer application is adapted to:
(i) receiving a users input including input concerning contract information,
(ii) sending received input to the communications module of the system for analysis and storage in the data store, and/or
(iii) receiving information from the communication module of the system and displaying that information to the user

Preferably, the computer application also adapts the computer or mobile telephone to upload photos of receipts, contracts or warranties to the system for storage in the system data store.

### BRIEF DESCRIPTION OF THE DRAWINGS

FIG. 1 is a concept diagram showing the system according to a preferred embodiment of the present invention,

FIG. 2 is a screen shot representation of a homepage of a website according to the system of FIG. 1,

FIG. 3 is a screen shot representation of a webpage for creating a new account on the system of FIG. 1,

FIG. 4 is a screen shot representation of a webpage for updating the account details of a user of the system of FIG. 1,

FIG. 5 is a screen shot representation of a webpage showing a report generating using the system of FIG. 1,

FIG. 6 is a screen shot representation of a webpage for adding new products to the system of FIG. 1,

FIG. 7 is a screen shot representation of a webpage for adding new contract to the system of FIG. 1,

FIG. 8 is a schematic representation of a mobile phone showing a log in webpage of a website according to the system of FIG. 1,

FIG. 9 is a schematic representation of a touch screen keyboard on the mobile phone of FIG. 8,

FIG. 10 is a schematic representation of a homepage of the website according to the system of FIG. 1 on the mobile phone of FIG. 8,

FIG. 11 is a schematic representation of a webpage which enables a user to select whether the reminder relates to product or a contract, wherein the webpage forms part of the website according to the system of FIG. 1 on the mobile phone of FIG. 8,

FIG. 12 is a schematic representation of a webpage of a website according to the system of FIG. 1 on the mobile phone of FIG. 8, wherein the touch screen keyboard has appeared to allow a user to enter details of the product to which the reminder relates,

FIG. 13 is a schematic representation of an image of a receipt captured using the camera on the mobile phone of FIG. 8, for upload to the system of FIG. 1,

FIG. 14 is a schematic representation of the home page of FIG. 10, wherein a user is entering the purchase date of the product into the system 10 using the touch screen keyboard of FIG. 9,

FIG. 15 is a schematic representation of the home page of FIG. 10, wherein a user is entering the warranty length of the product into the system 10 using the touch screen keyboard of FIG. 9,

FIG. 16 is a schematic representation of a webpage on the mobile phone of FIG. 8, which allows a user to enter details about the product covered by the warranty which is to be the subject of a reminder according to the system of FIG. 1,

FIG. 17 is a schematic representation of a webpage which enables a user to select whether the reminder relates to product or a contract, wherein the webpage forms part of the website according to the system of FIG. 1 on the mobile phone of FIG. 8,

FIG. 18 is a schematic representation of a webpage of a website according to the system of FIG. 1 on the mobile phone of FIG. 8, wherein the touch screen keyboard has appeared to allow a user to enter details of the contract to which the reminder relates,

FIG. 19 is a schematic representation of an image of a contract captured using the camera on the mobile phone of FIG. 8, for upload to the system of FIG. 1,

FIG. 20 is a schematic representation of the home page of FIG. 10, wherein a user is entering the date on which the contract was signed into the system 10 using the touch screen keyboard of FIG. 9,

FIG. 21 is a schematic representation of the home page of FIG. 10, wherein a user is entering the contract length into the system 10 using the touch screen keyboard of FIG. 9,

FIG. 22 is a schematic representation of a webpage on the mobile phone of FIG. 8, which allows a user to enter details about the contract which is to be the subject of a reminder according to the system of FIG. 1, and

FIG. 23 is a schematic representation of a homepage of the website, with details of a contract added thereto, according to the system of FIG. 1 on the mobile phone of FIG. 8.

### MODES FOR CARRYING OUT THE INVENTION

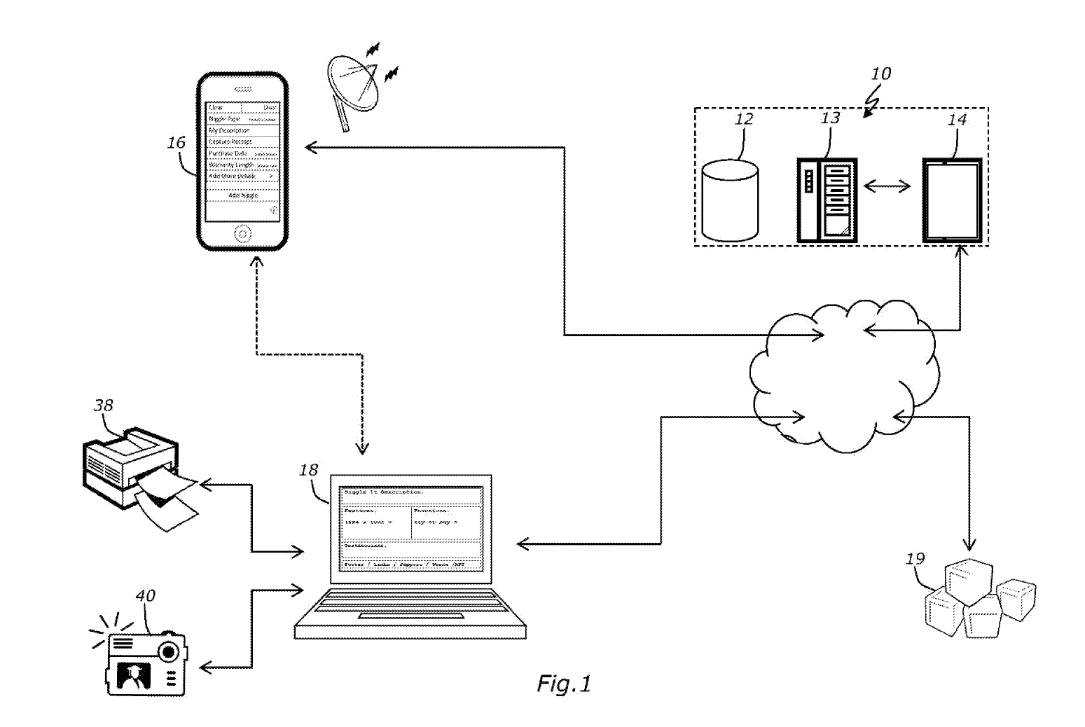

FIG. 1 shows a system 10 for tracking warranties and other time critical contracts, according to an embodiment of the present invention. The system 10 generally comprises a data store 12, a processor 14 and a communications module 13. The data store 12 is used for storing user information and the processor 14 is used for determining dates regarding time critical contracts, dates on which one or more warranties or one or more contracts will expire, or dates on which a reminder regarding the warranty expiry should be sent via a network, including the internet, to a device of a user.

The device may take the form of a mobile phone 16 adapted for connecting to system 10 via a web interface over an internet connection provided by the telecommunications network, or a mobile phone 16 that is loaded with special application software that is adapted to communicate with system 10 over an internet connection provided by the telecommunications network. In either embodiment the mobile phone may also access the system 10 via an internet connection provided over a local WIFI network.

The device may also take the form of a laptop or desktop computer 18 which is adapted to access the system 10 over the internet through a browser or installed software, or an intermediaries computer system 19 which is connected to system 10.

The system 10 also includes a communications module 13 for sending and receiving information to and from the mobile phone 16 or the computer 18. No data from the data store 12 is permanently stored on the mobile phone 16 or the computer 18, aside from a temporary cache of new information until the new information is transferred to the data store 12. This ensures continuity and facilitates the sharing of information by keeping it in a central repository.

The following description of the web-based interface is applicable to embodiments of the invention in which the user accesses a webpage on either the desktop or laptop computer 18, or via a browser session on mobile telephone 16.

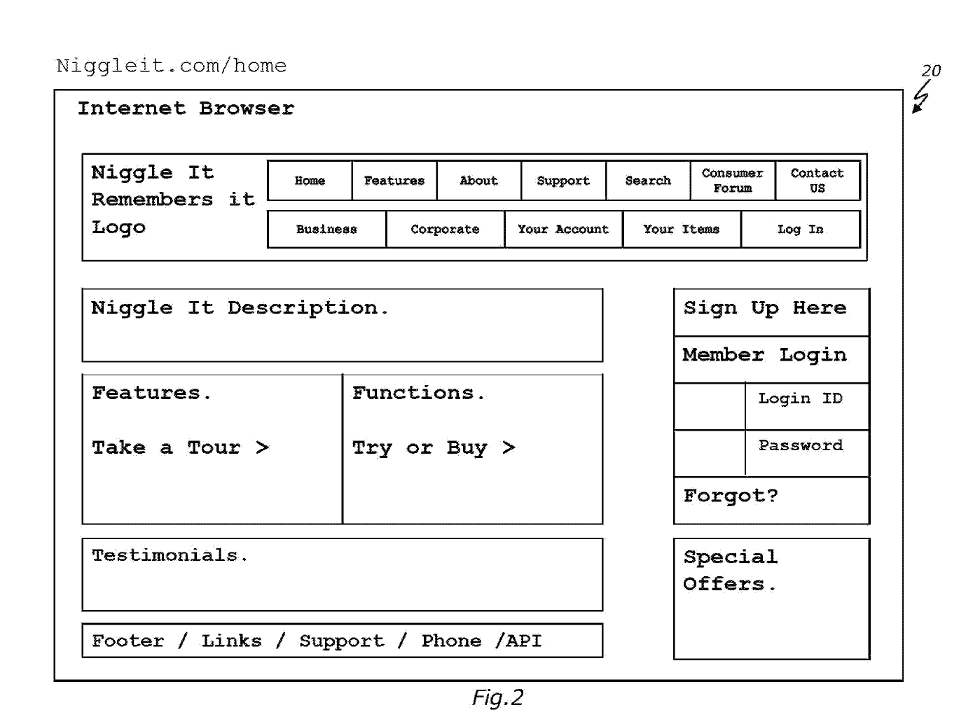

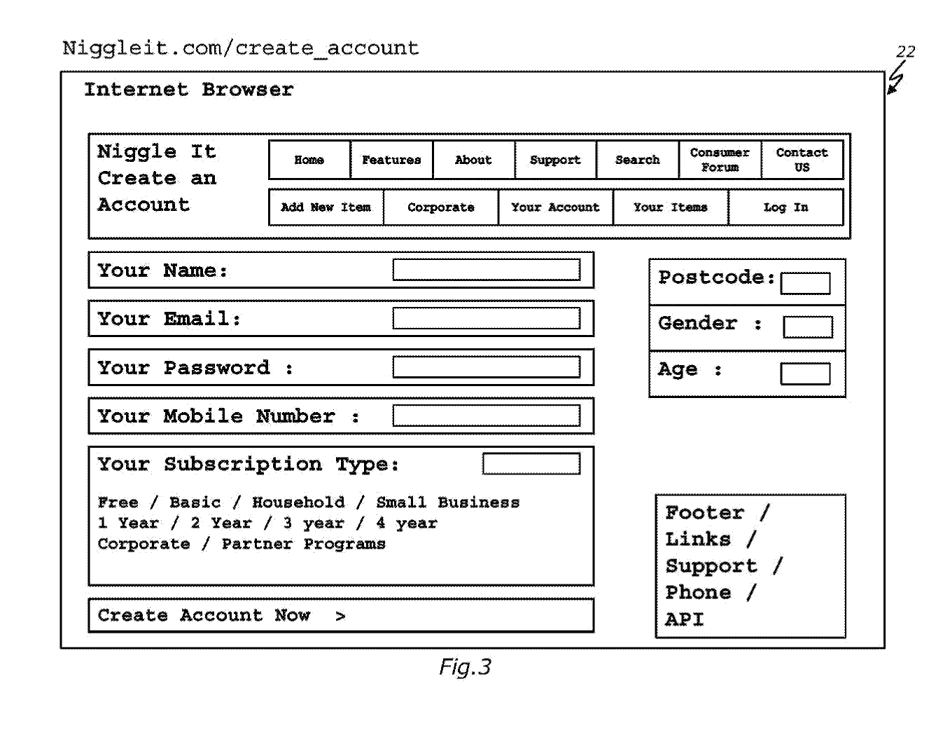

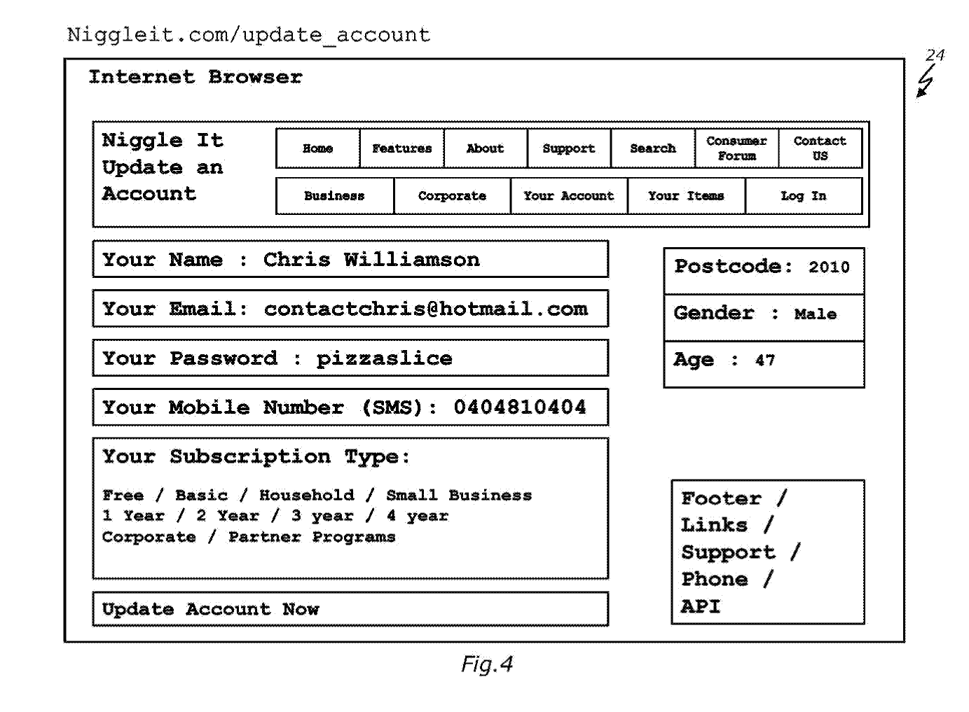

A user visits the homepage 20 of the system 10 which is depicted in FIG. 2, and may login using their username and password, or otherwise create an account via a webpage 22 shown in FIG. 3. Alternatively, other authentication information could be incorporated into the system, such as unique identifiers and/or information tokens which serve the purpose of allowing a user to securely login and authenticate themselves to system 10. After authentication, a user's account details may be updated thereafter via a webpage 24 shown in FIG. 4.

One or more users may be given access to a single account for items which are common to those users. For example, a landlord, may grant access to their account to real estate agents and tenants comprising reminders for items such as washing machines, dryers, dishwashers, or electric garage door operators. Notwithstanding that the description that follows describes a single user for a single account, the invention is not so limited.

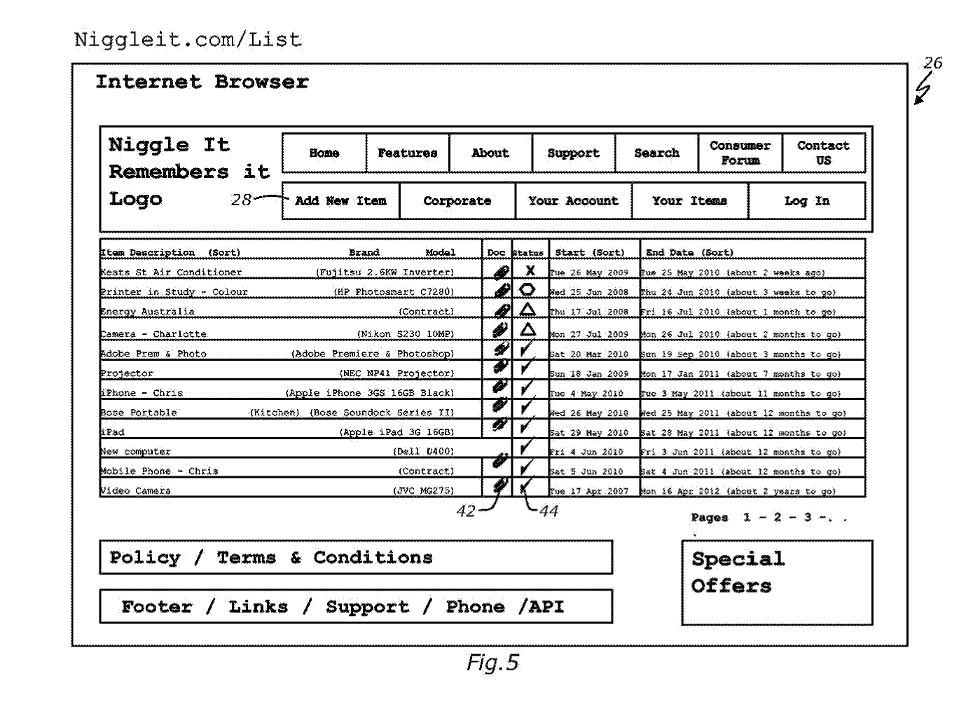

After logging in, the processor 14 accesses an account in the data store 12 to display a report of the user's various warranties and contracts, as shown on a webpage 26 in FIG. 5. The webpage 26 shows details of the items under warranty, including the make, model, date of purchase, the date of warranty expiry and a countdown. Columns can be sorted, searched and expired items can be revealed. Reports can be filtered to show warranties or contracts, and/or time critical documents.

Contracts which may be entered into the system 10 may include utility contracts, internet service provider contracts, mobile phone contracts, electricity supply contracts, software licence contracts, service contracts, support contracts, insurance contracts, fixed term contracts, or legal contracts. Other time critical documents which can be entered into the system 10 may include passports renewals, licence renewals, visas renewals, medical records (e.g. 10 year Tetanus shots), expiry dates for certain safety equipment such as fire extinguishers and fire blankets, will and testimony review cycles, gift vouchers with expiry dates, lay-by purchases, or time-based retail special offers, for example.

The layout of the report on the webpage 26 may be customised by clicking on the hyperlinked detail headings, for instance, to organise the items alphabetically, or chronologically according to the date of warranty expiry, item type or the date of purchase. Items can also be logically grouped together by a user. Further information (described below) can be obtained in respect of a particular item by clicking a colour coded hyperlinked description of the item, such as item 17 in FIG. 4.

Coloured fonts or highlighting may be used to indicate the status of an item. For instance, green may indicate items with eight weeks until expiry. Yellow may indicate items with four weeks until expiry. Red may indicate items with less than one week until expiry. Grey may indicate expired items and will be displayed for a period of time before be moved to an expired tab. The absence of a colour may indicate that an item has more than eight weeks until expiry.

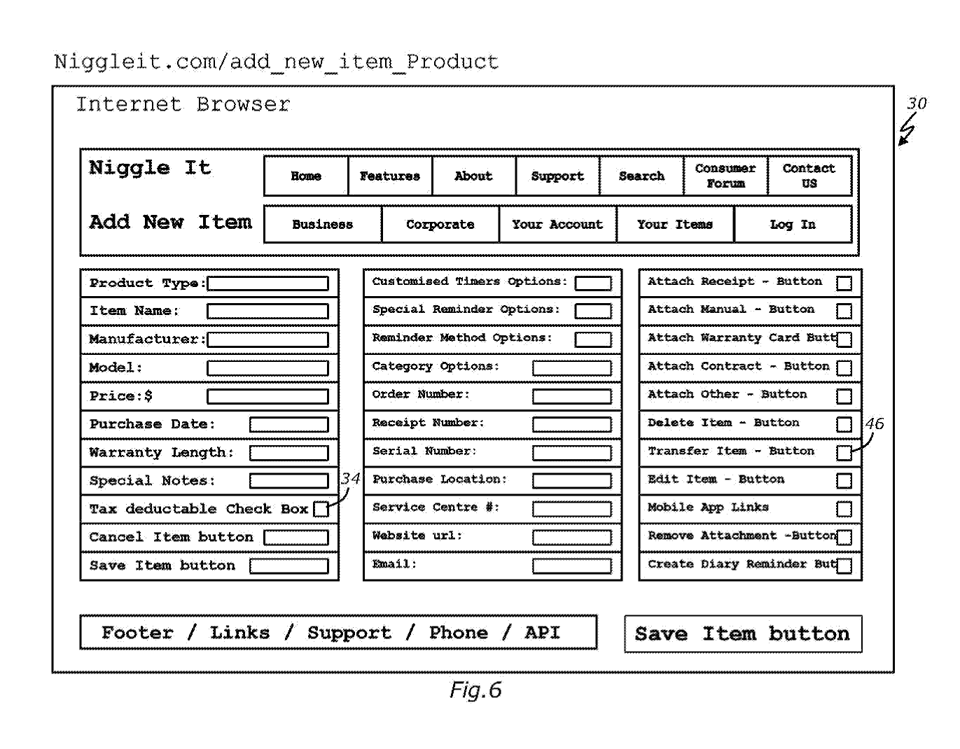

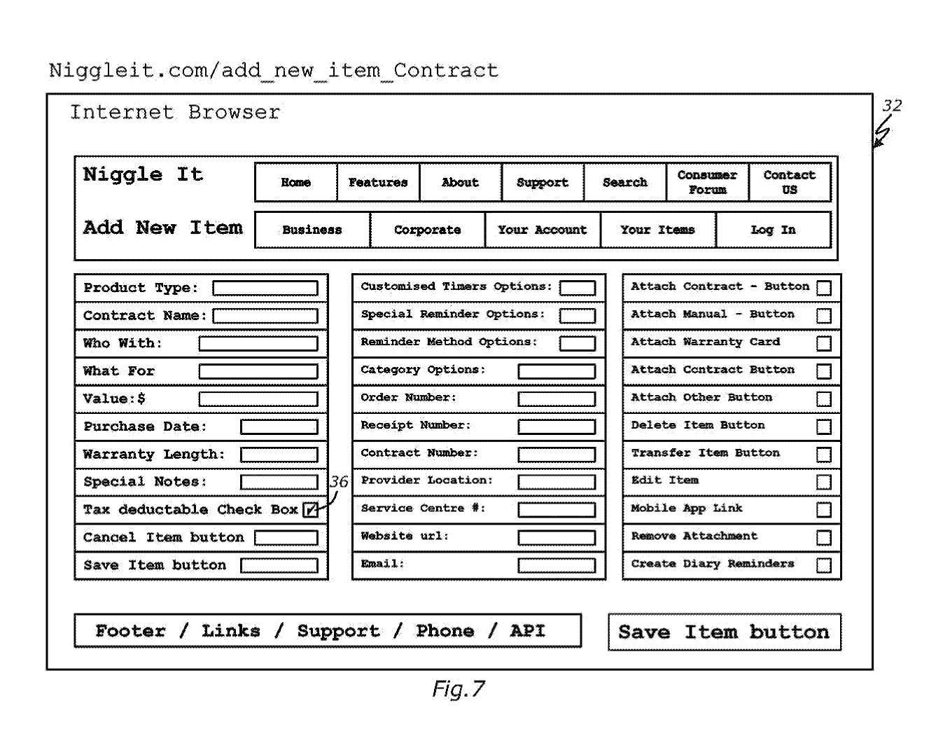

New items may be added by clicking the link 28 on the webpage 26 shown in FIG. 5, which takes the user to a webpage 30 shown in FIG. 6 for products, or a webpage 32 shown in FIG. 7 for contracts.

The webpages 30 and 32 allow the user to set the frequency of reminders and the preferred reminder method, such as email, SMS, MMS or social networking websites such as Twitter® or Facebook®. If a reminder email to a user bounces, a reminder can be sent via SMS to the mobile phone 16 of the user. Alternatively, if both email and SMS methods of reminding the user fail, the system 10 can send a reminder to the user via a social networking website.

Drop down menus with common product and service vendors are also provided to facilitate accurate data entry. In one embodiment of the invention, intermediaries' computer systems 19 may be connected to the system 10 so that an item's details can be automatically transferred to the data store 15 of the system 10. For instance, an intermediary such as a retailer may transfer information to the system 10 at point of sale of an item, with the purchaser's consent. If the purchaser does not have an existing account, the purchaser's email address can be used as a username and a temporary password can be provided by the retailer, which can be replaced by the user on first use of the system 10. In such an embodiment, the published application program interface of the system 10 can be used to integrate this feature into the vendor point of sale system.

In alternate embodiments of the invention, the system 10 may access an intermediary system 19 for information pertinent to an item being tracked. For example, system 10 may access warranty term and conditions from a vendor's intermediary system 19, or may access offers from the vendors such as extended warranty offers.

For vendors that do not provide applications or data schema accessible by system 10 (such as a source of XML information), the data store 12 may alternatively contain manufacturer's contact webpage. The processor 14 may access the data store 12 when sending reminders to a user, so that the reminder may include a link to manufacturer's contact webpage. Alternatively, the reminder may include a link to a search results page of a search for the manufacturer's name on a search engine such as Google®. The user may then contact the manufacturer for further information in respect of extending a warranty, making a claim under the warranty, upgrading an item, or replacing an item.

Items, such as automobiles, may require regular servicing as a condition of warranty. The system 10 provides reminders not only in respect of the expiry of the warranty, but also for events such as servicing, that may be a condition of a warranty.

The webpages 30 and 32 have checkboxes 34 and 36 (respectively) to indicate if an item is tax deductible. A reminder may be sent to the user shortly before the end of the financial year to claim the cost of the item in a tax return. Book keepers and Accountants may be given access to a user's account to obtain data, documents and receipts. The system 10 application program interface may also be used to provide access to the data and other accounting software packages, such as MYOB®, over the network.

The system 10 is adapted to enable a user to upload a copy of one or more documents such as a receipts, warranties, or contracts to the data store 12 for safe-keeping. The document can be scanned using a scanner 38, or photographed using a digital camera 40 or a digital camera on the mobile phone 16 (see FIG. 1). An uploaded document may be indicated by a hyperlink icon 42 shown on webpage 26 in FIG. 5. Documents which are uploaded may be classified, for example, as receipts, warranties, contracts, or other customised names which can be designated by different symbols 44, as shown on webpage 26 in FIG. 5. At any time, the receipt or warranty document may be retrieved from the system 10 by clicking on the hyperlink icon 42.

In the event that an item is sold, the user may select the transfer link 46 (see FIG. 6) and be taken to another webpage to enter the details of the new owner. In this way, the new owner may be sent warranty reminders and have online access to the receipt or the warranty document. The transfer link 46 may be particularly useful when transferring gift items to other people to remind them of the warranty expiry, and may also be useful for online traders and service providers such as Ebay®.

The system 10 also provides a consumer forum webpage accessible via link 48 which is shown on the homepage in FIG. 2. The consumer forum webpage is an online bulletin board with threads discussing various topics, including user's experiences with manufacturers when making claims for items under warranty.

The system 10 may also include a webpage having general information in regards to warranties and links to Consumer Commissions responsible for enforcing trade practices legislation (such as the Australian Competition and Consumer Commission), other industry ombudsmen, or product review websites (such as Choice® online).

In order to provide mobile access to the system 10, an application for a mobile phone (such as the iPhone® or Nexus One®, for example) may be downloaded from third party websites (such as the Apple iStore®) or the homepage 20. Alternatively, the website of the present invention may be optimised for display on a mobile phone, obviating the need for a separate downloadable application. In another embodiment of the invention, the application, once installed on the mobile phone, may merely provide a link to a mobile phone optimised version of the website of the present invention. What follows is a discussion of the embodiment which utilises an application that is not just a conduit to an optimised website, but rather, runs locally on the user's device.

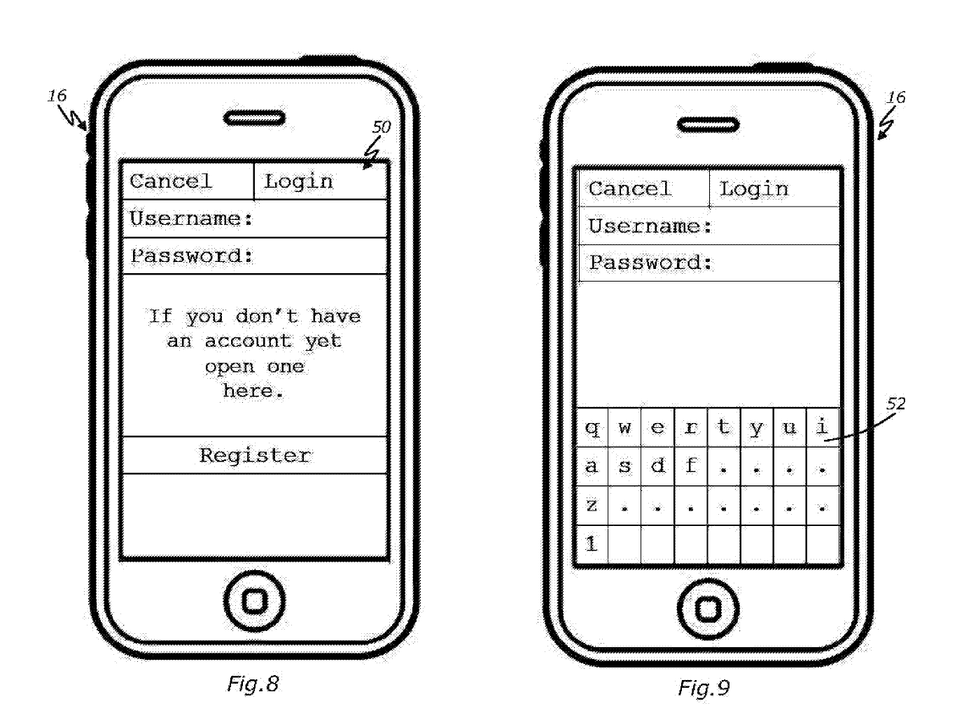

FIG. 8 shows an entry webpage 50 of the mobile phone application on the screen of the mobile phone 16. The entry webpage 50 requires an established user to enter their username and password to login to the system 10, or alternatively, to register a new account in the system 10. Touching the screen of the mobile phone 16 on the username or password fields activates the touch screen keyboard 52, as shown in FIG. 9.

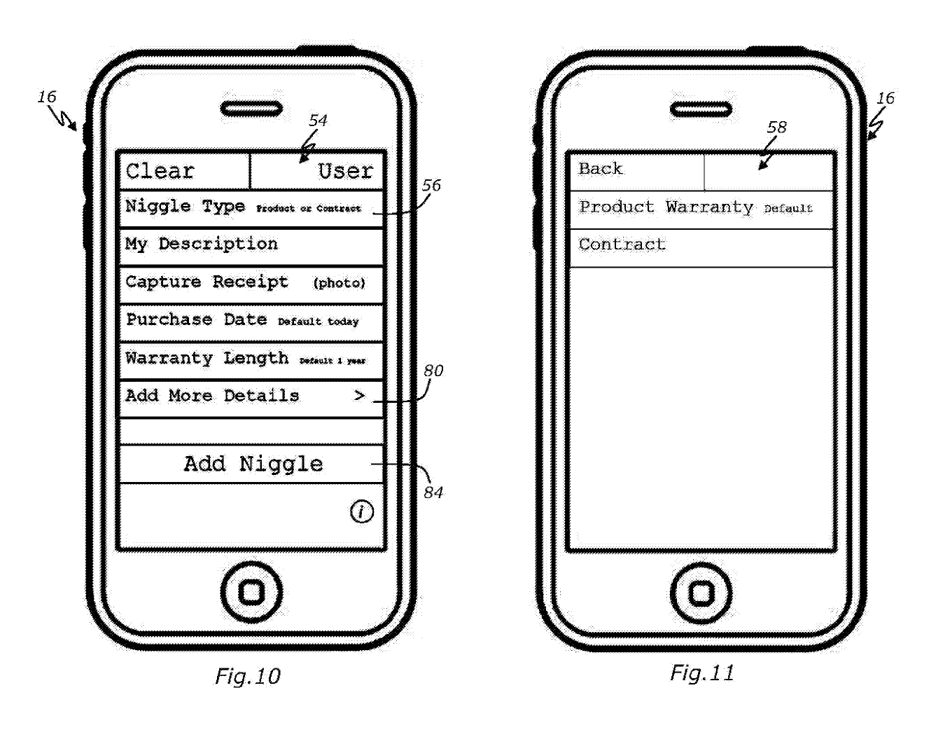

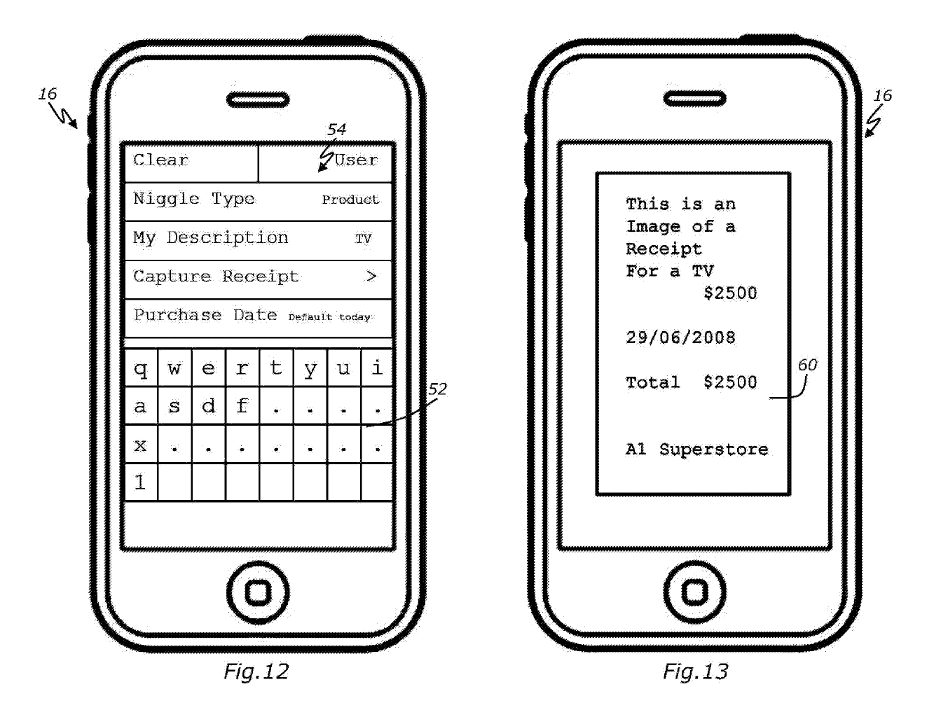

FIG. 10 shows the homepage 54 of the mobile phone application, which allows a user to add details for a new item. A user can elect whether the reminder relates to a product or a contract by pressing a type button 56, which takes the user to the webpage 58 shown in FIG. 11. The homepage 54 also provides the user with an option to capture one or more images of the relevant document, such as a receipt 60 shown in FIG. 13, using the camera on the mobile phone 16. The image can be uploaded to the data store 12 from an image which is captured within the application, or sourced from an image which was taken earlier and stored on the memory of the mobile phone 16.

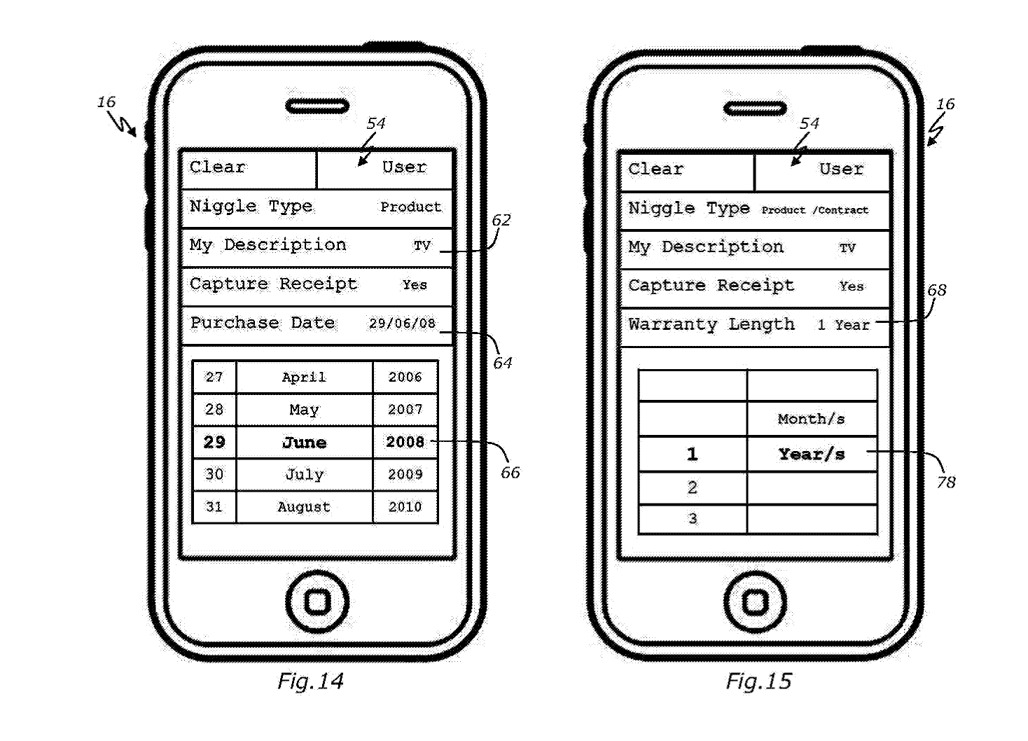

Other details which must be entered into the system 10 include an ad hoc description of the item via the ‘my description button’ 62, the warranty length and the purchase date (for which the default setting is the current date). After touching the purchase date button 64, the user can use a scroll feature 66 shown in FIG. 14 to select a date of purchase. Similarly, after pressing the warranty length button 68, the user can use the scroll feature 78 shown in FIG. 15 to select a warranty length in either months or years.

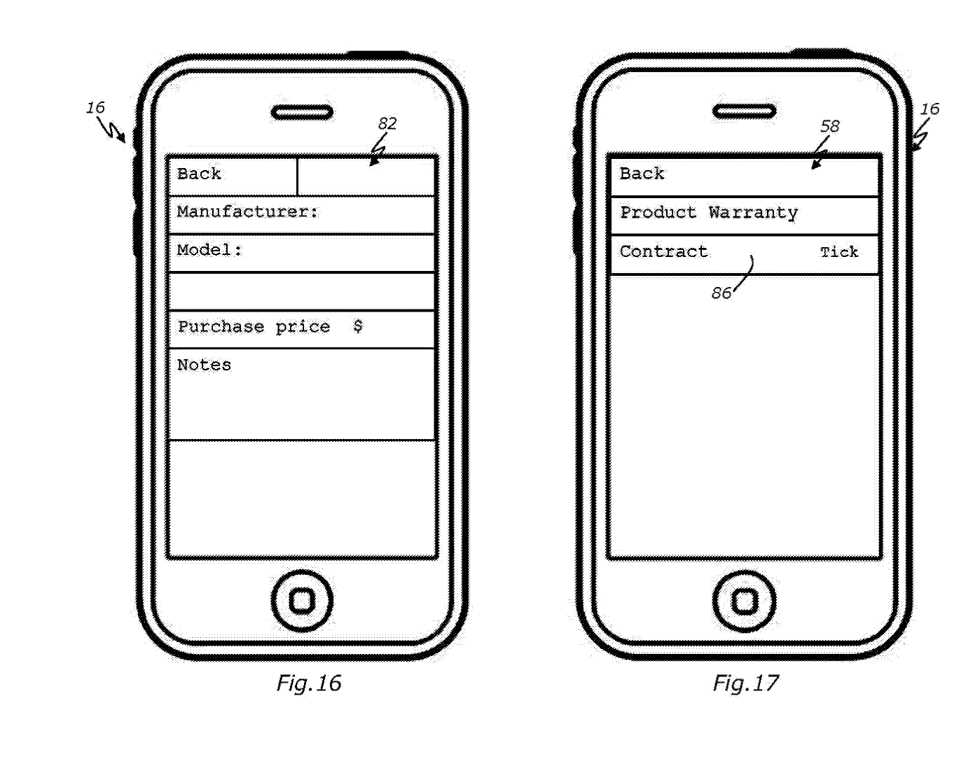

If the user touches the add more details button 80 shown in FIG. 10, the user is then taken to the webpage 82 shown in FIG. 16, and is required to enter details of the manufacturer of the product, the model of the product, the purchase price and any additional notes. If an intermediaries' computer system 19 is connected to the system 10 (see FIG. 11), then these details can be automatically populated by the intermediaries' computer system 19 at the point of sale, with the consent of the user and the provision of their username.

The user may enter details of a new contract into the system 10 by returning to the homepage 54 (see FIG. 11) and pressing the add new item button 84. The user will then be taken to the webpage 58 shown in FIG. 17, whereupon the contract button 86 can be pressed.

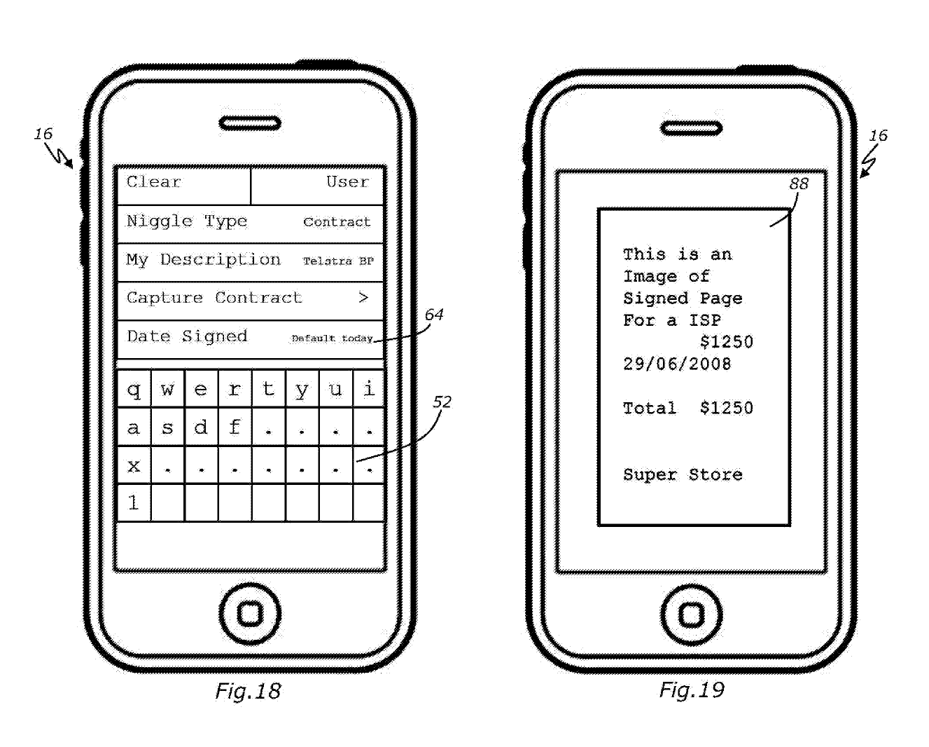

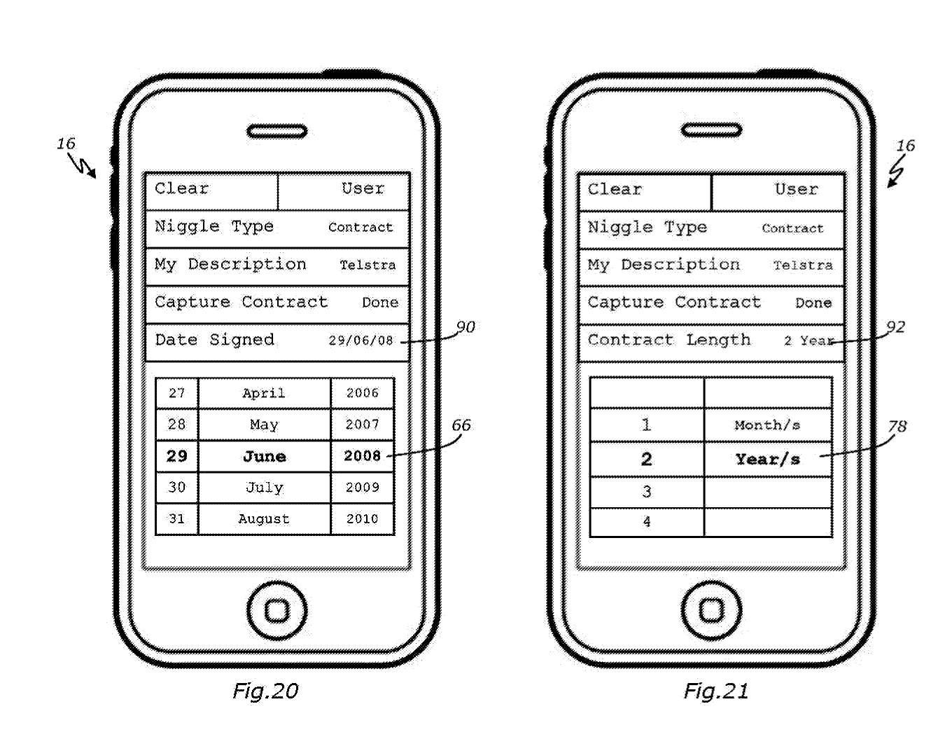

As shown in FIG. 18, the touch screen keyboard 52 appears so that the user may other details pertaining to the contract. FIG. 19 shows a representation of an image which is captured by the camera on the mobile phone 16 of a contract 88. After touching the date signed button 90, the user can use the scroll feature 66 shown in FIG. 20 to select a date of purchase. Similarly, after pressing the contract length button 92, the user can use the scroll feature 78 shown in FIG. 21 to select a warranty length in either months or years.

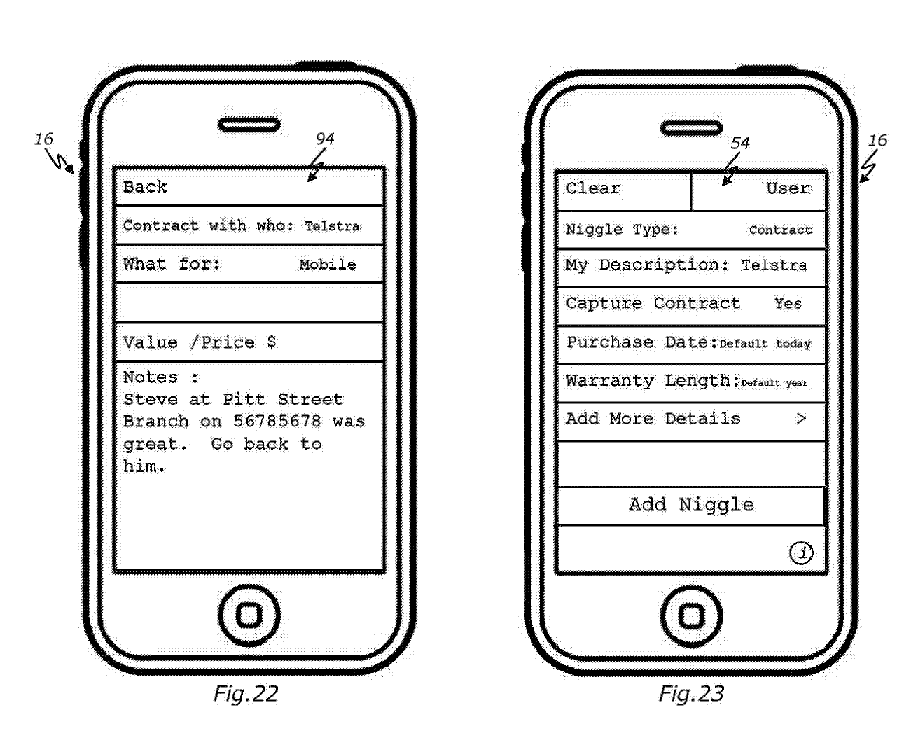

Details of the contract parties, subject matter, value and other relevant notes can be entered into the webpage 94 shown in FIG. 22. The homepage 54 of the mobile phone application with details of a contract is shown in FIG. 23.

Various modifications may be made in details of design and construction without departing from the scope and ambit of the invention.

### INDUSTRIAL APPLICABILITY

The present invention has applications in the computing and information technology industries.

1. A system for tracking warranties and other time critical contracts, the system comprising:
(a) a data store for storing at least:
a. authentication information for authenticating a user to the system and
b. contract information including start date and end date of the contracts being tracked;
(b) a processor adapted to access the data store and from the information made available in the data store, determining one or dates regarding time critical contracts, and for directing communications with a user via,
(c) a communications module adapted for sending and receiving information to and from a user device comprising a mobile telephone or a computer, wherein the user device further comprises input means, communication means and display means;
wherein the system is adapted to send to the user information concerning time critical contacts including at least, an alert before the end date of the contract being tracked.

2. The system of claim 1, the authentication information is comprised of a username and password.

3. The system of claim 2, wherein the username is the user's email address.

4. The system of claim 1, wherein the one or more dates regarding time critical contracts includes multiple dates on which reminders regarding pending contract expiry should be sent to a device of a user and wherein the processing means directs the communications module to send to a device of a user multiple reminders regarding pending contract expiry.

5. The system of claim 4, wherein the data store further includes one or more dates that relate to conditions of the contract and wherein the one or more dates regarding time critical contracts includes dates on which reminders regarding pending contract conditions should be sent to a device of a user and wherein the processing means directs the communications module to send to a device of a user reminders regarding pending contract conditions.

6. The system of claim 5, wherein the condition of the contract includes reminders to service any equipment which is the subject of a contract of warranty in advance of the deadline for servicing.

7. The system of claim 1, wherein the communications module communicates information to a user via either or all of email, SMS, MMS or via other social networking protocols and messaging platforms.

8. The system of claim 1, wherein the system is further adapted to receive from user devices, copies of receipts, warranty documents or contracts for storage in the data store for later retrieval by the user.

9. The system of claim 1, wherein additional information such as product specifications or terms and conditions can be stored in the data store, wherein the additional information is obtained from the vendor's web site or another repository of information.

10. The system of claim 1, wherein the system obtains the additional information automatically from a vendor's online repository of information or website, via the communications module and the internet.

11. The system of claim 1, wherein the system includes the ability to customise the arrangement of information reported to the user.

12. The system of claim 1, wherein the processing means is adapted to receive and process a request made by a user to transfer some or all of a user's information concerning time critical contracts to a different user's account.

13. The system of claim 1, wherein the system provides a forum for user's information which can be displayed via the display means to other users.

14. The system of claim 1, wherein each account holder can grant partial or complete access to their account to other persons where the other person is identified through their own authentication information, including username and password.

15. The system of claim 1, wherein the data store also records information in respect of other time critical documents that have an expiry date, other than contracts and the system is adapted to send reminder messages in advance of the expiry of the time critical documents to a user's device.

16. A computer or mobile phone when used to communicate with a system for tracking warranties and other time critical contracts, wherein the system comprises:
(a) a data store for storing at least:
(i) authentication information for authenticating a user to the system;
(ii) contract information including start date and end date of the contract being tracked;
(b) a processor adapted to access the data store and from the information made available in the data store, determining one or dates regarding time critical contracts, and for direction communications with a user via,
(c) a communications module adapted for sending and receiving information to and from a user device comprising a mobile telephone or computer;
wherein the computer or mobile telephone comprises input means, communication means, and display means for
(i) receiving a users input including input concerning contract information
(ii) sending the user's input to the communications module of the system for analysis and storage in the data store; and/or,
(iii) receiving information from the communication module of the system and displaying that information to the user.

17. The computer or mobile phone of claim 12, wherein the computer or mobile telephone also includes a camera for taking photos any of receipts, contracts or warranties for uploading to the system and for storage in the system data store.

18. A computer application for use on a computer or mobile telephone having input means, communication means and display means, wherein the computer application adapts the computer or mobile telephone to communicate with a system for tracking warranties and other time critical contracts, wherein the system comprises:
(a) a data store for storing at least:
(i) authentication information for authenticating a user to the system;
(ii) contract information including start date and end date of the contract being tracked;
(b) a processor adapted to access the data store and from the information made available in the data store, determining one or dates regarding time critical contracts, and for direction communications with a user via,
(c) a communications module adapted for sending and receiving information to and from a user device comprising a computer or mobile telephone, wherein the computer module further comprises input means and display means;
wherein the computer application is adapted to:
(i) receiving a users input including input concerning contract information,
(ii) sending received input to the communications module of the system for analysis and storage in the data store, and/or
(iii) receiving information from the communication module of the system and displaying that information to the user.

19. The computer application for use on a computer or mobile telephone of claim 14, wherein the computer application also adapts the computer or mobile telephone to upload photos of receipts, contracts or warranties to the system for storage in the system data store.
